(19) United States
(12) Patent Application Publication
(10) Pub. No.: US 2025/0036636 A1
(43) Pub. Date: Jan. 30, 2025

(54) INTELLIGENT VIRTUAL ASSISTANT SELECTION

(71) Applicant: Ford Global Technologies, LLC, Dearborn, MI (US)

(72) Inventors: Karthik Krishnamurthy, Novi, MI (US); Bhagyashri Satyabodha Katti, Novi, MI (US); Kwaku O. Prakah-Asante, Commerce Twp, MI (US)

(21) Appl. No.: 18/359,351

(22) Filed: Jul. 26, 2023

(51) Int. Cl. G06F 16/2457; G06F 16/2455; G06N 3/006

(52) U.S. Cl. CPC G06F 16/24578; G06F 16/2455; G06N 3/006

(57) ABSTRACT

A query is received from a user device. A domain and/or task is determined corresponding to the query. A set of similar queries to the query are identified using a collaborative selector. A plurality of virtual assistants (VAs) are ranked based on an average of customer feedback received from execution of the similar queries, the customer feedback including ratings of responses to the similar queries. One of the plurality of VAs is selected as being the one having a highest average of the customer feedback to use to respond to the query. The query is replied to using a selected response generated by the one of the plurality of VAs.

### TECHNICAL FIELD

Aspects of the present disclosure generally relate to approaches for intelligent virtual assistant selection.

### BACKGROUND

Speech-to-text and voice assistant applications can provide drivers or passengers the ability to interact with computing systems to obtain information, perform actions, or receive responses to queries. However, it can be difficult to manage a plurality of available speech-to-text or voice assistant services.

### SUMMARY

In one or more illustrative examples, a system for intelligent virtual assistant selection, includes an intelligent virtual assistant selection (IVAS) service executed by one or more hardware devices. The IVAS service configured to receive a query from a user device; determine a domain and/or task corresponding to the query; identify a set of similar queries to the query using a collaborative selector; select one of a plurality of virtual assistants (VAs) for use in responding to the query based on the similar queries; and reply to the query using a selected response generated by the one of the plurality of VAs.

In one or more illustrative examples, a method for intelligent virtual assistant selection by an IVAS service includes receiving a query from a user device; determining a domain and/or task corresponding to the query; identifying a set of similar queries to the query using a collaborative selector; ranking a plurality of VAs based on an average of customer feedback received from execution of the similar queries, the customer feedback including ratings of responses to the similar queries; selecting one of the plurality of VAs as being the one having a highest average of the customer feedback to use to respond to the query; and replying to the query using a selected response generated by the one of the plurality of VAs.

In one or more illustrative examples, a non-transitory computer-readable medium comprising instructions that, when executed by one or more hardware devices of a IVAS service, cause the IVAS service to perform operations including to receive a query from a user device; determine a domain and/or task corresponding to the query; identify a set of similar queries to the query using a collaborative selector; rank a plurality of VAs based on an average of customer feedback received from execution of the similar queries, the customer feedback including ratings of responses to the similar queries; select one of the plurality of VAs as being the one having a highest average of the customer feedback to use to respond to the query; and reply to the query using a selected response generated by the one of the plurality of VAs.

### BRIEF DESCRIPTION OF THE DRAWINGS

FIG. 1 illustrates an example system implementing intelligent virtual assistant selection;

FIG. 2 illustrates an example of user preferences for use of the intelligent virtual assistant selection;

FIG. 3 illustrates an example data flow for the intelligent virtual assistant selection;

FIG. 4 illustrates an example data log of user queries;

FIG. 5 illustrates an example of operation of the intelligent virtual assistant selection service in the explicit mode;

FIG. 6 illustrates an example of operation of the intelligent virtual assistant selection service in the implicit mode;

FIG. 7 illustrates an example process for the training of the intelligent virtual assistant selection service to operate in the implicit mode.

FIG. 8 illustrates an example process for the operation of the intelligent virtual assistant selection service in the implicit mode; and

FIG. 9 illustrates an example of a computing device for use in implementing aspects of the intelligent virtual assistant selection service.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

There are multiple speech-enabled virtual assistants (VAs) available today. A user may send a query to the VA, which may reply with an answer or by performing a requested action. Some VAs are specialized for different tasks or in different domains. Yet, it may be unclear to the user which VA to choose for a given query. When the user makes a request to a particular assistant and receives an unhelpful response, the user may try again with a different VA. This may lead to an unpleasant user experience.

Many users have a preference for which VA to use for what task or domain. For example some users prefer one VA for weather reports but prefer another for navigation tasks. Similarly, some users prefer one VA to handle IoT/smart home requests and a different VA to handle vehicle control requests. However, since VAs and their capabilities are always evolving, it is difficult for the user to keep a track of these changes to leverage the most out of these virtual assistants.

Aspects of the disclosure relate to approaches to automatically select the best VA to handle the user's query without the user having to be aware of the capabilities of each VA. This may reduce poor responses from the VAs and leads to a more seamless experience for the user. The approach may automatically select the VA to handle the task based on factors such as: user preferences, insights gained from user's interaction patterns and user feedback, and collaborative filtering of aggregated user behavior data. Further aspects of the disclosure are discussed in detail herein.

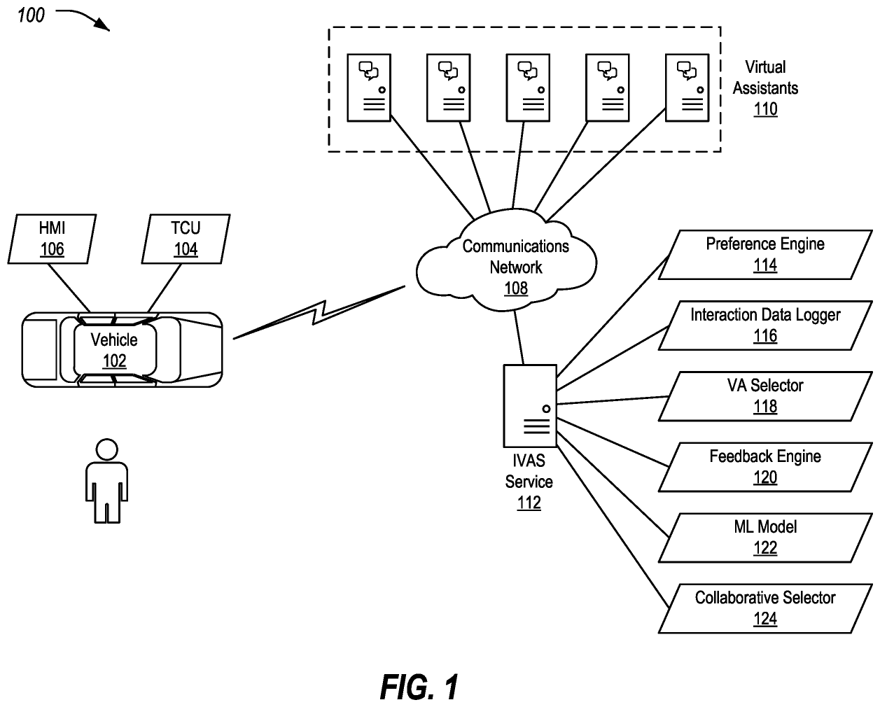

FIG. 1 illustrates an example system 100 implementing intelligent virtual assistant selection (IVAS). The system 100 includes a vehicle 102 having a telematics control unit (TCU) 104 and a human machine interface (HMI) 106. The TCU 104 may allow the vehicle 102 to communicate over a communications network 108 with remote devices, such as a plurality of VAs 110 and an IVAS service 112. The IVAS service 112 may include a preference engine 114, an interaction data logger 116, a VA selector 118, a feedback engine 120, a machine-learning (ML) model 122, and a collaborative selector 124. It should be noted that the system 100 is only an example, and systems 100 having more, fewer, or different elements may be used. For example, while a vehicle 102 having a TCU 104 is shown, the disclosed approach may be applicable to other environments in which VAs 110 may be used, such as a smartphone or smart speaker device.

The vehicle 102 may include various types of automobile, crossover utility vehicle (CUV), sport utility vehicle (SUV), truck, recreational vehicle (RV), boat, jeepney, plane or other mobile machine for transporting people or goods. In many cases, the vehicle 102 may be powered by an internal combustion engine. As another possibility, the vehicle 102 may be a battery electric vehicle (BEV) powered by one or more electric motors. As a further possibility, the vehicle 102 may be a hybrid electric vehicle powered by both an internal combustion engine and one or more electric motors, such as a series hybrid electric vehicle, a parallel hybrid electrical vehicle, or a parallel/series hybrid electric vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. Some vehicles 102 may be operator controlled, while other vehicles 102 may be autonomously or semi-autonomously controlled.

The vehicle 102 may include a TCU 104 configured to communicate over the communications network 108. The TCU 104 may be configured to provide telematics services to the vehicle 102. These services may include, as some non-limiting possibilities, navigation, turn-by-turn directions, vehicle health reports, local business search, accident reporting, and hands-free calling. The TCU 104 may accordingly be configured to utilize a transceiver to communicate with a communications network 108.

The TCU 104 may include various types of computing apparatus in support of performance of the functions of the TCU 104 described herein. In an example, the TCU 104 may include one or more processors configured to execute computer instructions, and a storage medium on which the computer-executable instructions and/or data may be maintained. A computer-readable storage medium (also referred to as a processor-readable medium or storage) includes any non-transitory (e.g., tangible) medium that participates in providing data (e.g., instructions) that may be read by a computer (e.g., by the processor(s)). In general, the processor receives instructions and/or data, e.g., from the storage, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and either alone or in combination, Java, C, C++, C#, Fortran, Pascal, Visual Basic, Python, JavaScript, Perl, etc.

The vehicle 102 may also include an HMI 106 located within the cabin of the vehicle 102. The HMI 106 may be configured to receive voice input from the occupants of the vehicle 102. The HMI 106 may include one or more input devices, such as microphones or touchscreens, and one or more output devices, such as displays or speakers.

The HMI 106 may gather audio from a cabin or interior of the vehicle 102 using the input devices. For example, the one or more microphones may receive audio including voice commands or other audio data from within the cabin. The TCU 104 may perform actions in response to the voice commands. In one example, the HMI 106 may forward on commands to other devices for processing.

The HMI 106 may provide output to the cabin or interior of the vehicle 102 using the output devices. For example, the one or more displays may be used to display information or entertainment content to the driver or passengers. The displays may include one or more of an in-dash display, gauge cluster display, second row display screen, third row display screen, or any other display at any other location in the vehicle 102. For example, video or other content may be displayed on a display for entertainment purposes. Additionally, a notification, prompt, status of the vehicle 102, status of a connected device, or the like may be displayed to a user. In another example, the one or more speakers may include a sound system or other speakers for playing music, notification sounds, phone call audio, responses from voice assistant services, or the like. For example, the HMI 106 may provide audio such as music, audio accompanying a video, audio responses to user requests, or the like to the speakers.

The communications network 108 may provide communications services, such as packet-switched network services (e.g., Internet access, voice over internet protocol (VOIP) communication services), to devices connected to the communications network 108. An example of a communications network 108 is a cellular telephone network. For instance, the TCU 104 may access the cellular network via connection to one or more cellular towers. To facilitate the communications over the communications network 108, the TCU 104 may be associated with unique device identifiers (e.g., mobile device numbers (MDNs), Internet protocol (IP) addresses, etc.) to identify the communications of the TCU 104 on the communications network 108 as being associated with the vehicle 102.

The VAs 110 may include various digital assistants that uses various technologies to understand voice input and provide relevant results or perform the requested actions. The VA 110 may perform speech recognition to convert received audio input from an audio signal into text. The VA 110 may also perform other analysis on the input, such as semantic analysis to understand the mood of the user. The VA 110 may further perform language processing on the input, as processed, to understand what task is being asked of the VA 110. The VA 110 may perform the requested task and utilize voice synthesis to return the results or an indication of whether the requested function was performed. The input provided to the VA 110 may be referred to as a prompt or an intent. The VAs 110 may include, as some non-limiting examples, AMAZON ALEXA, GOOGLE ASSISTANT, APPLE SIRI, FORD SYNC, and MICROSOFT CORTANA.

The IVAS service 112 may be a computing device configured to communicate with the vehicle 102 and the VAs 110 over the communications network 108. The IVAS service 112 may be configured to aid the user in the selection and personalization of use of the various VAs 110. This selection and personalization may be accomplished in an explicit approach and in an implicit approach.

In the explicit approach, the IVAS service 112 selects the VA 110 to use based on preferences that are explicitly configured and set by the user. This information may be a part of the user's personal profile. For example, the HMI 106 may be used to allow the user to select a mapping of available VAs 110 to various domains (or in other examples to specific tasks).

A domain may refer to a specific knowledge, topic or feature that the VA 110 can handle. For example, navigation may be a domain, weather may be a domain, music may be a domain and so on. Tasks, however, may be individual element that are within a domain. In an example, moving to a next song, requesting a specific song to be played, and changing the volume may be tasks within the music domain. Receiving directions to a destination, asking for alternative routes, adding a refueling stop, etc., may be tasks within the navigation domain.

The preference engine 114 may be configured to allow the user to set preferences for using the VAs 110 for different domains. The preferences may be stored as a lookup table with a domain-to-VA mapping.

As one possibility, the preference engine 114 may interact with the HMI 106 to provide a listing of the domains, such as navigation, music, weather, etc., where for each category the user may explicitly select which of the VAs 110 is to be used. For instance, the user may select to use a first VA 110 for navigation, a second VA 110 for music, and a third VA for weather. As another possibility, the HMI 106 may additionally or alternatively provide a listing of the tasks, e.g., categories according to domain. In some examples, the use may be able to set a VA 110 for a domain, and also override the selection for a specific task within the domain.

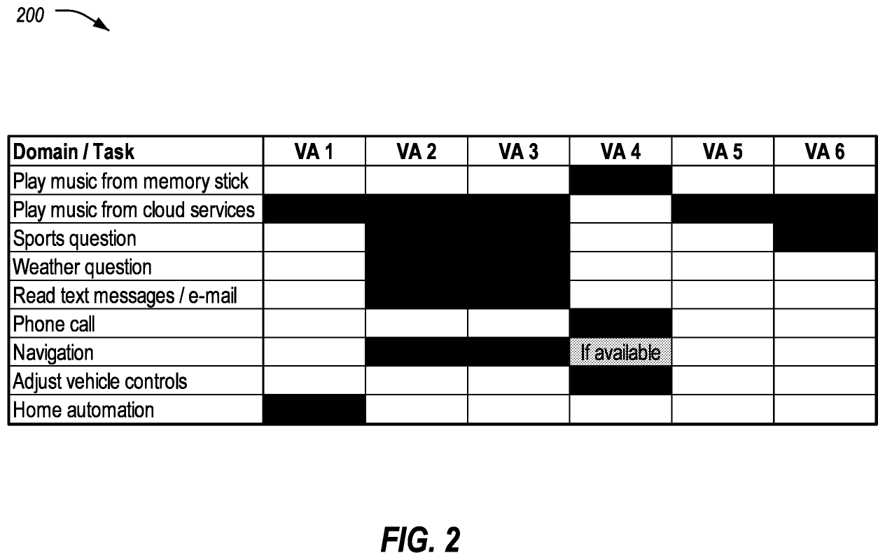

FIG. 2 illustrates an example of such user preferences 200. As shown, an example mapping of user preferences 200 for a set of tasks to six VAs 110 is shown, namely VA1, VA2, VA3, VA4, VA5, VA6. For example, for the task of playing music from a memory stick, the user prefers to use VA4. Or for the task of navigation, the user may prefer VA4, if available (e.g., if the vehicle 102 is equipped with navigation use the local vehicle navigation VA 110), but may also accept the use of VA2 or VA3.

The user may set the user preferences 200 to handle each domain and/or task by specific VAs 110 or can choose multiple domains to be handled by a single VA 110. The user preferences 200 may be implemented, in one example, as a hash map which contains a table of key-value pair data, where the key is defined to indicate the domain and the value indicates VA 110 of choice selected by the user.

Referring back to FIG. 1, in the implicit approach the IVAS service 112 selects the VA 110 to use based on factors instead of or in addition to the user's explicit settings. For example, these factors may include learning the user's usage patterns, collaborative filtering, and user feedback. For instance, the IVAS service 112 may identify that for navigation, the second VA 110 performs best based on the user's previous interactions, other user's interactions, and/or user feedback ratings of the second VA 110 when performing navigation tasks.

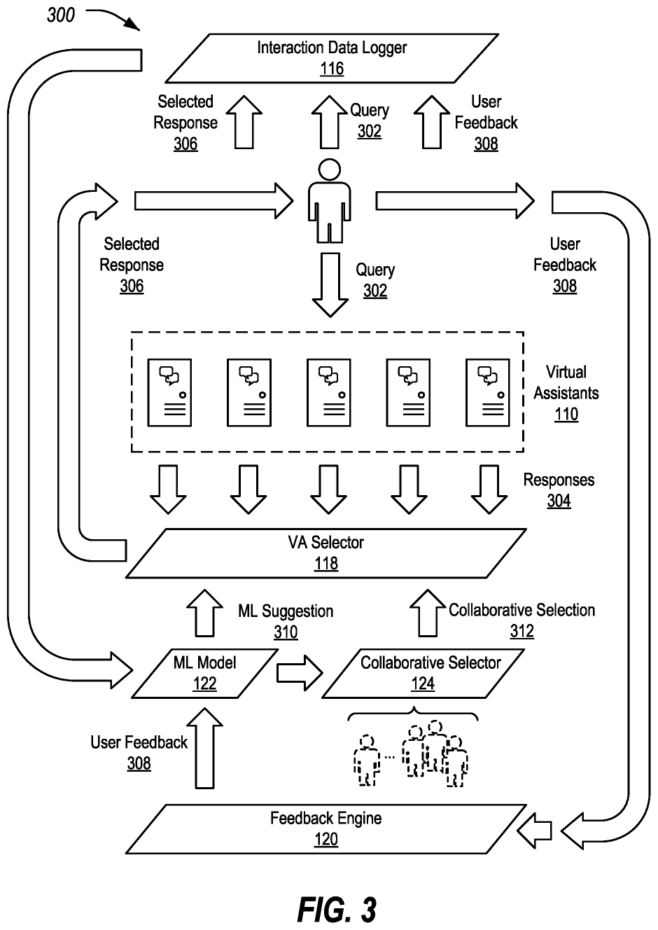

FIG. 3 illustrates an example data flow 300 for the operation of the IVAS service 112. Referring to FIG. 3, and with continuing reference to FIG. 1, to implement the explicit and/or the implicit approaches the IVAS service 112 may implement one or more of the preference engine 114, the interaction data logger 116, the VA selector 118, the feedback engine 120, the ML model 122, and the collaborative selector 124. It should be noted that while the IVAS service 112 is discussed in terms of an IVAS service 112, one or more aspects of the operation of the IVAS service 112 may be implemented onboard the vehicle 102, and/or using another device such as a user's mobile phone.

In the data flow 300, a user may provide a query 302 to the IVAS service 112. For example, the user may utilize the HMI 106 of the vehicle 102 to capture spoken commands in an audio signal, which may be provided by the TCU 104 of the vehicle 102 over the communications network 108 to the IVAS service 112. In some examples, speech-to-processing text may be performed by the vehicle 102 and a textual version of the query 302 may be provided to the IVAS service 112.

Responsive to the IVAS service 112 receiving the query 302, the IVAS service 112 may perform an intent classification to identify the domain and/or task to which the query 302 belongs. This intent classification may be performed using various natural language processing (NLP) techniques. In an example, a set of tasks may be defined. These tasks are sometimes referred to as intents. Each task may be triggered by a group of similar phrases falling under a common name. A labeled training set of such phrased mapped to the respective tasks may be used to train a machine learning model. At runtime in an inference mode, the machine learning model may be used to bin the received input into its corresponding task and/or domain including the task. For example, the query 302 “What's the weather like in Chicago?” may be identified as being a “weather” domain request. Similarly, the query 302 “Get me directions to the nearest Starbucks” may be identified as being a “navigation” domain request.

In the explicit approach, based on the user preferences 200, the IVAS service 112 may send the query 302 to the user's selected VA 110 and receive a response 304 from the user-selected VA 110. The IVAS service 112 may provide the response 304 from the user-selected VA 110 back to the user. This may be referred to as the selected response 306. The selected response 306 may be returned to the TCU 104 over the communications network 108 from the IVAS service 112 and passed to the HMI 106 to be provided to the user.

Turning to the implicit approach, the IVAS service 112 may learn the user's VA 110 usage patterns in the background in a shadow mode for an initial duration (e.g., 60 days). In the shadow mode, user feedback 308 is requested from the user when a selected response 306 is provided from the VAs 110. For instance, the vehicle 102 may use the HMI 106 to ask the user for the user feedback 308 after presenting the selected response 306. This user feedback 308 may then be sent by the vehicle 102 to the IVAS service 112 similar to how the query 302 is sent.

The user feedback 308 may include a ‘rating score’ on a scale (e.g., positive, neural, or negative; a score along a scale such as zero to five, one to five, negative three to positive three, etc.). The user may provide the user feedback 308 to indicate whether the VA 110 handled the query 302 successfully, and/or to provide the user's perception of the quality of the selected response 306 provided to the user.

The user feedback 308 may be elicited by the feedback engine 120. The feedback engine 120 may be configured to catalog which VA 110 the user prefers for which domain of query 302, e.g., the user prefers a first VA 110 for Navigation queries 302 and a second VA 110 for shopping, etc. This may allow the feedback engine 120 to construct and maintain the user preference 200.

The interaction data logger 116 may be configured to log the interactions of the user with the IVAS service 112. These interactions may include the user feedback 308 as well as other contextual information.

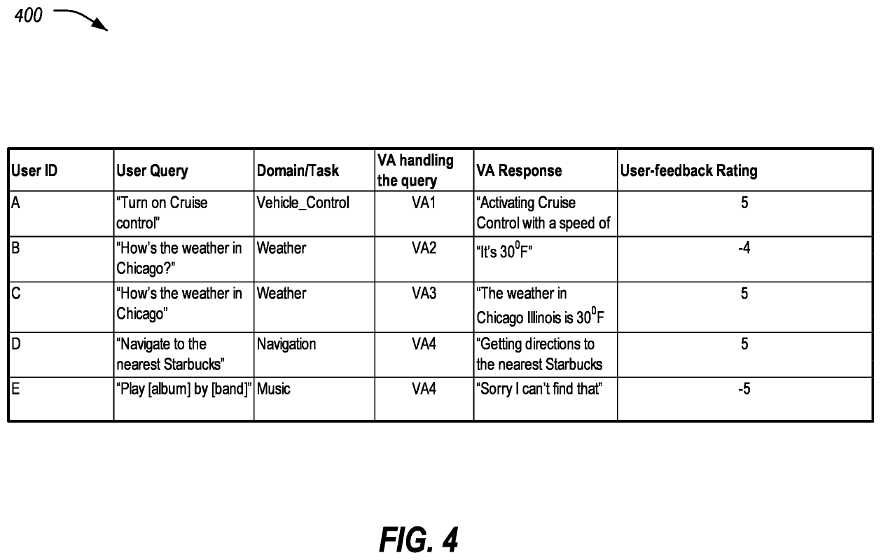

FIG. 4 illustrates an example data log 400 of user interactions with the VAs 110. As shown, the data log 400 includes various information, such as identifiers of the users providing the feedback, a textual representation of the query 302, the inferred domain and/or task for the query 302, an indication of which of the VAs 110 handled the query 302, a textual representation of the response 304 to the query 302 from the VA 110, and the user feedback 308 rating of the response 304 and/or overall interaction with the VA 110.

Returning to FIG. 3, using the data log 400 the ML model 122 may be configured to learn patterns from the interaction of the user with the VAs 110 along with the user feedback 308 rating scores during the explicit mode. This may be referred to sometimes as a shadow mode of operation, as the system 100 shadows the user's interactions. Using the information, the ML model 122 may be trained by the IVAS service 112 to update the user preferences 200 for selection of the VAs 110 for specific tasks and/or domains for future interactions. Once trained, in an inference mode the ML model 122 may receive the query 302 and may offer a ML suggestion 310 indicating which VA 110 (or a set of preferred VAs 110 in decreasing order of relevance) to use to respond to the query 302.

The IVAS service 112 may use any of various machine learning techniques for training the ML model 122, such as a decision tree approach to learn and update the preferences for VA 110 selection for future interactions. The approach is not limited to decision trees, and other ML techniques can be used as well. For training, the ML model 122 may receive one or more of the following as inputs: (i) data log 400 records including information such as the type or domain of request being made, an indication of the VA 110 that handled the request and the response 304 from the VA 110; (ii) user feedback 308 including the rating score provided by the user for the corresponding response 304 from the VA 110; (iii) a frequency of similar requests made by other users; and/or (iv) user feedback 308 ratings from other users for the similar requests.

Responsive to the ML model 122 of the IVAS service 112 learning the user preferences 200 with a confidence of at least a predefined confidence threshold, the IVAS service 112 may activate the implicit mode for the user. For example, the IVAS service 112 may show the learned user preferences 200 to the user for confirmation. Once confirmed by the user, the IVAS service 112 may deploy the ML model 122 to transition to the implicit mode. Or the IVAS service 112 may apply the ML model 122 automatically responsive to the ML model 122 reaching the accuracy level and/or confidence threshold. Once activated in the implicit mode, the user need not keep track of which VA 110 can handle what task. The user may simply make the query 302 and the best VA 110 for handling the task may be provided automatically in a ML suggestion 310 from the ML model 122.

Thus, in the implicit mode the VA selector 118 may be configured to select the appropriate VA 110 to handle the requested query 302 based on the ML suggestion 310 from the ML model 122.

Moreover, the VA selector 118 may be further configured to utilize learned preferences from a plurality of users to further enhance the suggestions. For instance, the collaborative selector 124 may be utilized by the IVAS service 112 to determine preferences across users for similar tasks and/or domains to that of the query 302.

In an example, for a query 302 in the navigation domain, if the fourth VA 110 is the most requested VA 110 by the most people for such tasks and if the rating scores provided by those users is positive and high, the collaborative selector 124 may indicate a collaborative suggestion 312 that the fourth VA 110 may be selected automatically to handle the query 302 from the user.

More formally, for a particular query 302 Q requested by the user, the collaborative selector 124 may perform the collaborative operations including:

```
IDENTIFY TASK / DOMAIN FOR QUERY Q
FIND SIMILAR QUERIES Qₛᵢₘ TO Q
FIND VAₘₐₓ FOR Qₛᵢₘ AND FIND R_{avg} FOR VA
SORT VA DESCENDING BY R_{avg} FOR TASK / DOMAIN
FOR EACH VAₘₐₓ
  IF R_{avg} > R_{threshold} AND Qₛᵢₘ > Q_{threshold}
    SELECT VA
  END IF
END FOR
```

where:
Qₛᵢₘ is the similar queries 302 from other users based on collaborative filtering;
VAₘₐₓ is a maximum number of times a particular VA 110 is selected to handle the particular task or domain;
R_{avg} is the average value of the user feedback 308 ratings provided by other users for the specific VA 110 for similar requests;
R_{threshold} is a minimum value of user feedback 308 required for automatic selection of the VA 110; and
Q_{threshold} is a minimum quantity of the Qₛᵢₘ for automatic selection of the VA 110.

In addition to the automated selection, it should be noted that the VA selector 118 may allow for the user to override the selected VA 110. Also, the VA selector 118 may be configured to store the responses 304 from each VA 110 for a particular query 302 Q, as well as send the selected response 306 to the user. This also allows the user to cycle through or otherwise select different responses 304 from the multiple VA 110 in shadow mode (e.g., if the selected response 306 is not helpful), without having to perform a second query 302 cycle to the VAs 110.

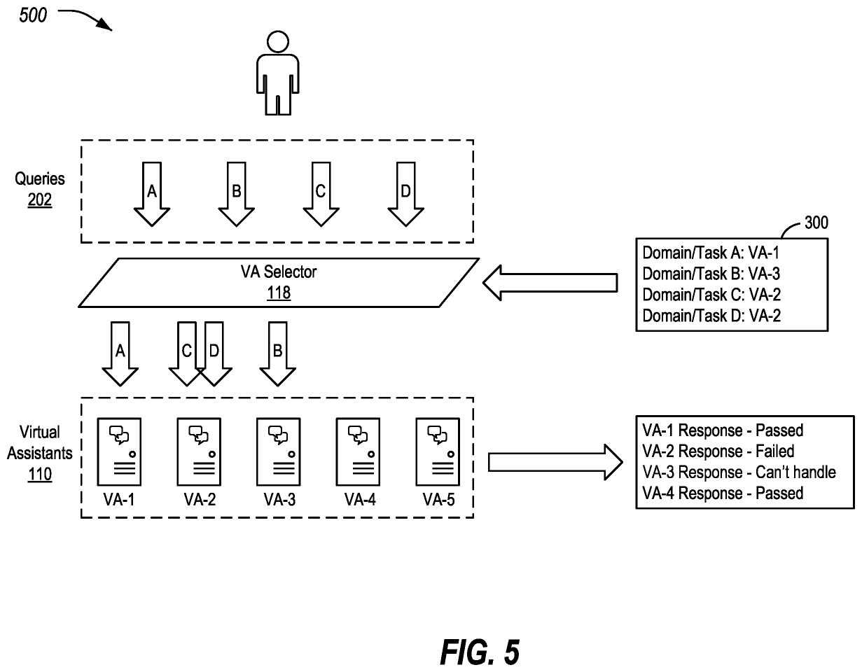

FIG. 5 illustrates an example 500 of operation of the IVAS service 112 in the explicit mode. As shown, the user preferences 200 indicate an express mapping of the domains and/or tasks to the VAs 110. Using the mapping, the VA selector 118 chooses the VA 110 that is listed in the user preferences 200. However, in such an approach, if the VA 110 is unable to handle the specific query 302 or type of query 302, then the query 302 may complete without a useful selected response 306.

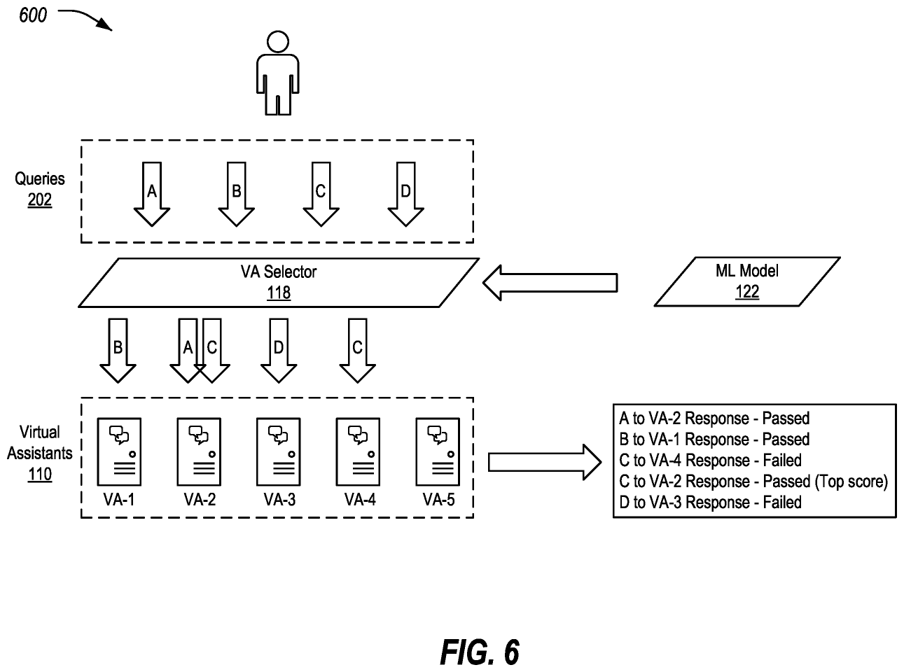

FIG. 6 illustrates an example 600 of operation of the IVAS service 112 in the implicit mode. Here, the ML model 122 is instead used to choose the selected response 306. Moreover, as the VA selector 118 may ask multiple VAs 110 if there is an issue with the selected VA 110, the VA selector 118 may be able to automatically move to the second most highly rated VA 110 if the first most highly rated VA 110 is unable to complete a specific query 302.

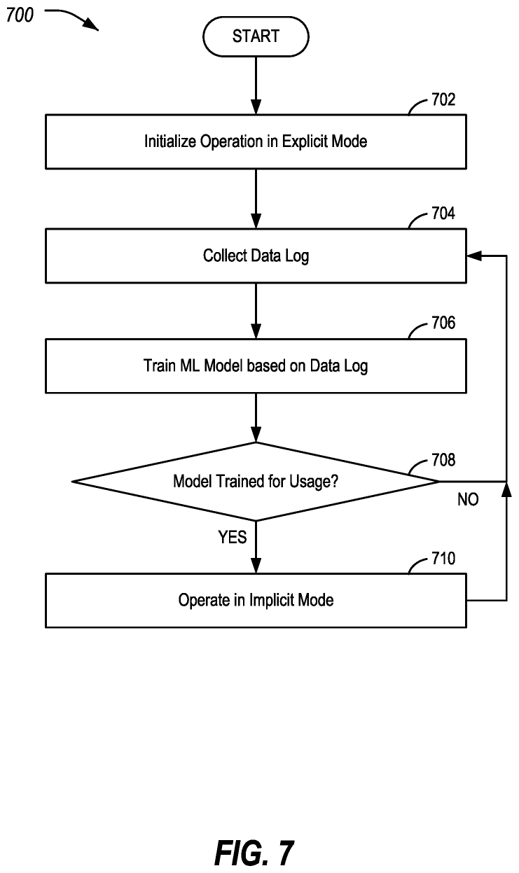

FIG. 7 illustrates an example process 700 for the training of the IVAS service 112 to operate in the implicit mode. In an example, the process 700 may be performed by the components of the IVAS service 112 in the context of the system 100.

At operation 702, the IVAS service 112 initializes operation in the explicit mode. In the explicit mode, the IVAS service 112 may utilize the preference engine 114 to receive and manage user preferences 200 from the user. In an example, the preference engine 114 may interact with the HMI 106 to provide a listing of the domains, such as navigation, music, weather, etc., where for each category the user may explicitly select which of the VAs 110 is to be used. In the explicit mode, based on the user preferences 200, the IVAS service 112 may send any received queries 302 to the user's selected VA 110 and receive a response 304 from the user-selected VA 110. The IVAS service 112 may provide the response 304 from the user-selected VA 110 back to the user. The IVAS service 112 may also use the feedback engine 120 to receive user feedback 308 with respect to the provided responses 304.

At operation 704, the IVAS service 112 collects entries of the data log 400. The data log 400 may include various information, such as identifiers of the users providing the feedback, a textual representation of the query 302, the inferred domain and/or task for the query 302, an indication of which of the VAs 110 handled the query 302, a textual representation of the response 304 to the query 302 from the VA 110, and the user feedback 308 rating of the response 304 and/or overall interaction with the VA 110. An example data log 400 is shown in FIG. 4.

At operation 706, the IVAS service 112 trains the ML model 122 using the data log 400. For example, using the data log 400 as training data, the ML model 122 may learn patterns from the interaction of the user with the VAs 110 along with the user feedback 308 rating scores during the explicit mode. For instance, ML model 122 may be trained by the IVAS service 112 to update the user preferences 200 for selection of the VAs 110 for specific tasks and/or domains for future interactions.

Once trained, in an inference mode the ML model 122 may receive the query 302 and may offer a ML suggestion 310 indicating which VA 110 (or a set of preferred VAs 110 in decreasing order of relevance) to use to respond to the query 302.

At operation 708, the IVAS service 112 determines whether the IVAS service 112 is trained for usage. In an example, the IVAS service 112 may segment the data log 400 into a training portion and a testing portion. Periodically, from time to time, and/or as new data log 400 entries are received, the IVAS service 112 may determine whether the accuracy of the ML model 122 is sufficient for use in the implicit mode. In an example, the IVAS service 112 may train the IVAS service 112 using the training portion of the data, and may use the testing portion with the indicated user preference 200 to confirm that the ML model 122 is providing accurate results within at least a predefined accuracy level and/or confidence. If so, control proceeds to operation 710. If not, control returns to operation 704 to await further data log 400 entries and/or to perform further training cycles.

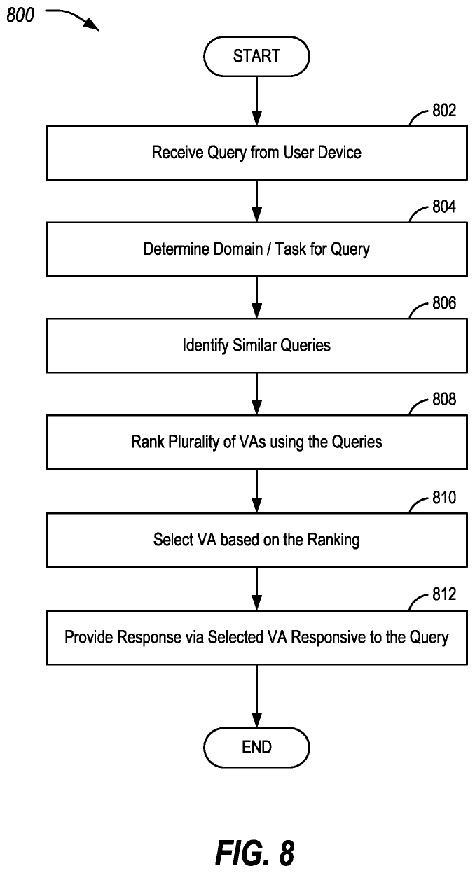

At operation 710, the IVAS service 112 operates in the implicit mode. In the implicit mode, the user may simply make the query 302 and the best VA 110 for handling the task may be provided automatically in a ML suggestion 310 from the ML model 122 and/or via a collaborative suggestion 312 from the collaborative selector 124. Further aspects of the performance of the system 100 in the implicit mode are discussed in detail with respect to FIG. 8. After or during operation 710, it should be noted that continued training and/or refinement of the ML model 122 may be performed. e.g., in accordance with operations 704 and 706.

FIG. 8 illustrates an example process 800 for the operation of the IVAS service 112 in the implicit mode. In an example, as with the process 700, the process 800 may be performed by the components of the IVAS service 112 in the context of the system 100.

At operation 802, the IVAS service 112 receives a query 302 from a user device. In an example, the user device may be a vehicle 102 and the user may utilize the HMI 106 of the vehicle 102 to capture spoken commands in an audio signal, which may be provided by the TCU 104 of the vehicle 102 over the communications network 108 to the IVAS service 112. In some examples, speech-to-processing text may be performed by the vehicle 102 and a textual version of the query 302 may be provided to the IVAS service 112. In another example, the user device may be a mobile phone or a smart speaker, which may similarly send the query 302 to the IVAS service 112.

At operation 804, the IVAS service 112 determines a domain and/or task specified by the query 302. In an example, the IVAS service 112 performs an intent classification to identify the domain and/or task to which the query 302 belongs. This intent classification may be performed using various NLP techniques. In an example, a set of tasks may be defined. These tasks are sometimes referred to as intents. Each task may be triggered by a group of similar phrases falling under a common name. A labeled training set of such phrased mapped to the respective tasks may be used to train a machine learning model. At runtime in an inference mode, the machine learning model may be used to bin the received input into its corresponding task and/or domain including the task

At operation 806, the IVAS service 112 identifies similar queries 302 related to the received query 302. In an example, the IVAS service 112 may access the data log 400 to retrieve queries 302 that are categorized to the same domain and/or task as the received query 302.

At operation 808, the IVAS service 112 ranks a plurality of VAs 110 using the similar queries 302. In an example, the IVAS service 112 may rank the plurality of VAs 110 based on an average of customer feedback received from execution of the similar queries 302. In some examples, the IVAS service 112 may exclude VAs from consideration that have not received at least a minimum quantity of user feedback. In some examples, the IVAS service 112 may exclude VAs from consideration that have not received at least a minimum average rating score from the customer feedback. Further aspects of the ranking are discussed with respect to the collaborative operations detailed with respect to FIG. 3.

At operation 810, the IVAS service 112 selects a VA 110 from the plurality of VAs 110 based on the ranking. In an example, the IVAS service 112 may select the one of the plurality of VAs 110 having a highest average of the customer feedback for use in responding to the query 302.

At operation 812, the IVAS service 112 provides a selected response 306 from the VAs 110 to reply to the query 302. In an example, the reply may be provided to the user device responsive to receipt of the query 302. Thus, the IVAS service 112 may allow the system 100 to personalize and select the best VAs 110 for specific tasks and/or domains based on user preferences 200, collaborative filtering via the collaborative selector 124, and user feedback 308. After operation 812, the process 800 ends.

Variations on the process 800 are possible. In an example, the IVAS service 112 may, responsive to receiving user feedback 308 that the selected response 306 is not desired, select a second of the plurality of VAs 110 having a second highest average of the customer feedback for use in responding to the query 302, identify a second selected response 306 as the one of the responses 304 from the second selected VA.

Moreover, the IVAS service 112 may continue to learn and adapt over time to the individual's usage and interaction patterns, as well as the usage patterns and associated user feedback 308 ratings from other users. The IVAS service 112 may accordingly automatically select the best VA to handle the user's query 302 without the user having to be aware of the capabilities of each VA. This may reduce poor responses 304 from the VAs 110 and leads to a more seamless experience for the user.

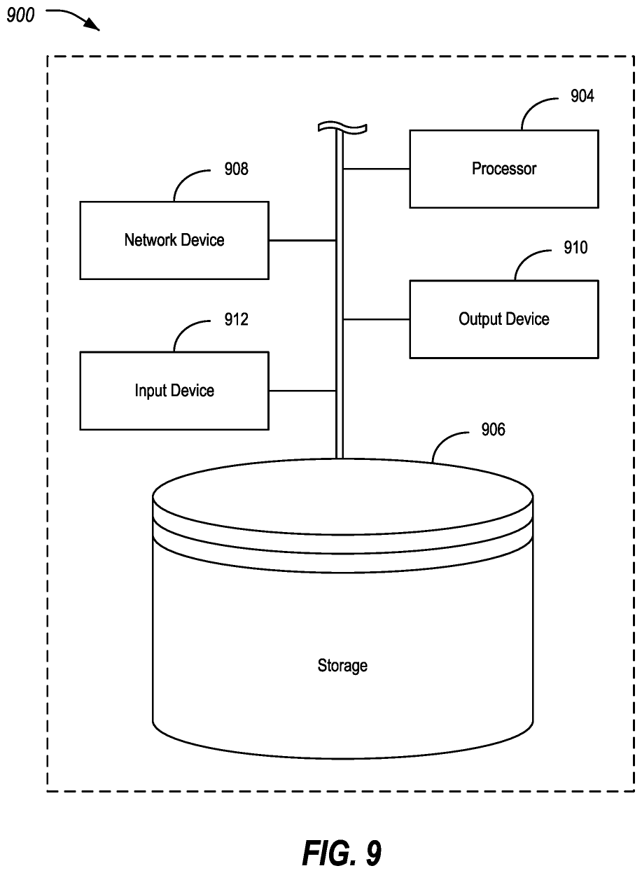

FIG. 9 illustrates an example 900 of a computing device 902 for use in implementing aspects of the intelligent virtual assistant selection service. Referring to FIG. 9, and with reference to FIGS. 1-8, the vehicles 102 or other user devices, TCU 104, communications network 108, VAs 110, and IVAS service 112, may be examples of such computing devices 902. As shown, the computing device 902 may include a processor 904 that is operatively connected to a storage 906, a network device 908, an output device 910, and an input device 912. It should be noted that this is merely an example, and computing devices 902 with more, fewer, or different components may be used.

The processor 904 may include one or more integrated circuits that implement the functionality of a central processing unit (CPU) and/or graphics processing unit (GPU). In some examples, the processors 904 are a system on a chip (SoC) that integrates the functionality of the CPU and GPU. The SoC may optionally include other components such as, for example, the storage 906 and the network device 908 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stages (MIPS) instruction set families.

Regardless of the specifics, during operation the processor 904 executes stored program instructions that are retrieved from the storage 906. The stored program instructions, such as those of the VAs 110, preference engine 114, interaction data logger 116, VA selector 118, feedback engine 120, and collaborative selector 124, include software that controls the operation of the processors 904 to perform the operations described herein. The storage 906 may include both non-volatile memory and volatile memory devices. The non-volatile memory includes solid-state memories, such as not AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100. This data may include, as non-limiting examples, the ML model 122, the user preferences 200, and the data log 400.

The GPU may include hardware and software for display of at least two-dimensional (2D) and optionally three-dimensional (3D) graphics to the output device 910. The output device 910 may include a graphical or visual display device, such as an electronic display screen, projector, printer, or any other suitable device that reproduces a graphical display. As another example, the output device 910 may include an audio device, such as a loudspeaker or headphone. As yet a further example, the output device 910 may include a tactile device, such as a mechanically raiseable device that may, in an example, be configured to display braille or another physical output that may be touched to provide information to a user.

The input device 912 may include any of various devices that enable the computing device 902 to receive control input from users. Examples of suitable input devices that receive human interface inputs may include keyboards, mice, trackballs, touchscreens, voice input devices, graphics tablets, and the like.

The network devices 908 may each include any of various devices that enable the devices discussed herein to send and/or receive data from external devices over networks. Examples of suitable network devices 908 include an Ethernet interface, a Wi-Fi transceiver, a Li-Fi transceiver, a cellular transceiver, or a BLUETOOTH or BLUETOOTH low energy (BLE) transceiver, or other network adapter or peripheral interconnection device that receives data from another computer or external data storage device, which can be useful for receiving large sets of data in an efficient manner.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A system for intelligent virtual assistant selection, comprising:
an intelligent virtual assistant selection (IVAS) service executed by one or more hardware devices, the IVAS service configured to:
receive a query from a user device;
determine a domain and/or task corresponding to the query;
identify a set of similar queries to the query using a collaborative selector;
select one of a plurality of virtual assistants (VAs) for use in responding to the query based on the similar queries; and
reply to the query using a selected response generated by the one of the plurality of VAs.

2. The system of claim 1, wherein the IVAS service is further configured to:
rank the plurality of virtual assistants (VAs) based on an average of customer feedback received from execution of the similar queries; and
select the one of the plurality of VAs as being the one having a highest average of the customer feedback to use to respond to the query.

3. The system of claim 2, wherein the IVAS service is further configured to:
initialize operation of the IVAS service in an explicit mode in which user preferences are utilized to select the one of the plurality of VAs to use to respond to the query;
collect entries in a data log, the entries including the customer feedback to responses received from the plurality of VAs;
train a machine-learning (ML) model using the data log to infer updates to the user preferences; and
update the user preferences for selection of the VAs for specific tasks and/or domains for future interactions.

4. The system of claim 2, wherein the IVAS service is further configured to exclude any of the VAs from consideration that have not received at least a minimum quantity of user feedback.

5. The system of claim 2, wherein the IVAS service is further configured to exclude any of the VAs from consideration that have not received at least a minimum average rating score from the customer feedback.

6. The system of claim 2, wherein the customer feedback includes ratings of responses to the similar queries.

7. The system of claim 2, wherein the IVAS service is further configured to:
responsive to receiving user feedback that the selected response is not desired;
select a second of the plurality of VAs having a second highest average of the customer feedback for use in responding to the query;
identify a second selected response as the one of the responses from the second selected VA; and
send the second selected response to the user device.

8. The system of claim 7, wherein the IVAS service is further configured to:
send the query to each of the plurality of VAs;
receive responses from each of the plurality of VAs; and
identify the selected response as the response from the selected one of the VAs.

9. The system of claim 1, wherein the user device is a vehicle.

10. The system of claim 1, wherein the user device is a mobile phone.

11. A method for intelligent virtual assistant selection by an IVAS service, comprising:
receiving a query from a user device;
determining a domain and/or task corresponding to the query;
identifying a set of similar queries to the query using a collaborative selector;
ranking a plurality of VAs based on an average of customer feedback received from execution of the similar queries, the customer feedback including ratings of responses to the similar queries;
selecting one of the plurality of VAs as being the one having a highest average of the customer feedback to use to respond to the query; and
replying to the query using a selected response generated by the one of the plurality of VAs.

12. The method of claim 11, further comprising:
initializing operation of the IVAS service in an explicit mode in which user preferences are utilized to select the one of the plurality of VAs to use to respond to the query;
collecting entries in a data log, the entries including the customer feedback to responses received from the plurality of VAs;
training a machine-learning (ML) model using the data log to infer updates to the user preferences; and
updating the user preferences for selection of the VAs for specific tasks and/or domains for future interactions.

13. The method of claim 11, further comprising excluding any of the VAs from consideration that have not received at least a minimum quantity of user feedback.

14. The method of claim 11, further comprising excluding any of the VAs from consideration that have not received at least a minimum average rating score from the customer feedback.

15. The method of claim 11, further comprising, responsive to receiving user feedback that the selected response is not desired:
selecting a second of the plurality of VAs having a second highest average of the customer feedback for use in responding to the query;
identifying a second selected response as the one of the responses from the second selected VA; and
sending the second selected response to the user device.

16. The method of claim 15, further comprising:
sending the query to each of the plurality of VAs;
receiving the responses from each of the plurality of VAs; and
identifying the selected response as the response from the selected one of the VAs.

17. A non-transitory computer-readable medium comprising instructions that, when executed by one or more hardware devices of a IVAS service, cause the IVAS service to perform operations including to:
receive a query from a user device;
determine a domain and/or task corresponding to the query;
identify a set of similar queries to the query using a collaborative selector;
rank a plurality of VAs based on an average of customer feedback received from execution of the similar queries, the customer feedback including ratings of responses to the similar queries;
select one of the plurality of VAs as being the one having a highest average of the customer feedback to use to respond to the query; and
reply to the query using a selected response generated by the one of the plurality of VAs.

18. The medium of claim 17, further comprising instructions that, when executed by the one or more hardware devices of the IVAS service, cause the IVAS service to perform operations including to:
initialize operation of the IVAS service in an explicit mode in which user preferences are utilized to select the one of the plurality of VAs to use to respond to the query;
collect entries in a data log, the entries including the customer feedback to responses received from the plurality of VAs;
train a machine-learning (ML) model using the data log to infer updates to the user preferences; and
update the user preferences for selection of the VAs for specific tasks and/or domains for future interactions.

19. The medium of claim 17, further comprising instructions that, when executed by the one or more hardware devices of the IVAS service, cause the IVAS service to perform operations including one or more of to:
exclude any of the VAs from consideration that have not received at least a minimum quantity of user feedback; or
exclude any of the VAs from consideration that have not received at least a minimum average rating score from the customer feedback.

20. The medium of claim 17, further comprising instructions that, when executed by the one or more hardware devices of the IVAS service, cause the IVAS service to perform operations including to:
send the query to each of the plurality of VAs;
receive the responses from each of the plurality of VAs; and
responsive to receiving user feedback that the selected response is not desired:
select a second of the plurality of VAs having a second highest average of the customer feedback for use in responding to the query,
identify a second selected response as the one of the responses from the second selected VA, and
send the second selected response to the user device.
